(19) United States
(12) Patent Application Publication
(10) Pub. No.: US 2026/0091616 A1
(43) Pub. Date: Apr. 2, 2026

(54) CHASSIS FOR A COMMERCIAL VEHICLE

(71) Applicant: DAIMLER TRUCK AG, Leinfelden-Echterdingen (DE)

(72) Inventors: Uwe MAUZ, Esslingen (DE); Soeren ANDRES, Leutenbach (DE); Rene SCHRÖDER, Korb (DE)

(21) Appl. No.: 18/993,724

(22) PCT Filed: Jun. 23, 2023
(86) PCT No.: PCT/EP2023/067123

§ 371 Date: Jan. 13, 2025

(30) Foreign Application Priority Data
Jul. 14, 2022 (DE) 10 2022 117 576.6

(51) Int. Cl. B60B 35/00; B60G 11/27

(52) U.S. Cl. CPC B60B 35/003; B60G 11/27; B60G 2202/152; B60G 2202/413

(57) ABSTRACT

A chassis for a commercial vehicle includes a vehicle axle by means of which at least two vehicle wheels of the commercial vehicle, the wheels being rotatable around a respective wheel rotational axis, can be supported on a vehicle frame of the commercial vehicle. At least one adjusting device is provided so that the vehicle axle is mounted to pivot relative to the vehicle frame around a pivot axis running oblique or perpendicular to the respective wheel rotational axis to achieve cornering or changes of direction of the commercial vehicle.

### BACKGROUND AND SUMMARY OF THE INVENTION

Exemplary embodiments of the invention relate to a chassis for a commercial vehicle.

DE 10 2018 122 991 A1 discloses a steerable axle for a vehicle, having a steering linkage for transmitting a steering movement on the vehicle wheels of the axle and having a braking device, wherein the steering linkage is acted upon with a braking force in a braking state of the braking device.

Additionally, DE 197 02 457 A1 discloses a commercial vehicle having a vehicle frame, a front axle steered by means of axle-pivot steering, and a steered rear axle. Furthermore, an articulated vehicle is taken as known from AT 28 158 E. AT 371 408 B also discloses a self-tracking axle for a vehicle.

Exemplary embodiments of the invention are directed to a chassis for a commercial vehicle so that maneuvering capability of the commercial vehicle can be especially improved.

The invention relates to a chassis for a commercial vehicle. For example, the commercial vehicle is a heavy goods vehicle, in particular as a tractor unit. For example, the commercial vehicle is a semi-trailer truck, which comprises the tractor unit. The semi-trailer truck can comprise in particular a semi-trailer. Thus, the semi-trailer truck can be understood as a pair consisting of the tractor unit and the semi-trailer, for example. Alternatively, the commercial vehicle can be designed as an omnibus or as a passenger bus, for example. For example, the commercial vehicle is designed as a heavy-duty commercial vehicle.

The chassis has at least one vehicle axle, by means of which at least two vehicle wheels of the commercial vehicle, the wheels being rotatable around a respective wheel rotational axis, can be or are supported, in particular directly, on a vehicle frame of the commercial vehicle. This means that the vehicle wheels are held or supported on the vehicle frame via the vehicle axle, in particular in a completely produced state of the commercial vehicle.

The respective vehicle wheel can be understood, in particular, as a respective ground contact element of the commercial vehicle. A first of the vehicle wheels can be rotated relative to the vehicle frame around a wheel rotational axis of the first vehicle wheel, in particular referred to as a first wheel rotational axis. The second of the vehicle wheels can be rotated relative to the vehicle frame around a wheel rotational axis of the second vehicle wheel, in particular referred to as a second wheel rotational axis. Driving the commercial vehicle on a road can be achieved by rotating the respective vehicle wheel. For example, the respective wheel rotational axis runs in particular at least substantially parallel to the vehicle transverse direction of the commercial vehicle.

The chassis can comprise the respective vehicle wheel. This means that the respective vehicle wheel can be a part of the chassis. Alternatively, the respective vehicle wheel may not be a part of the chassis. This means that the chassis does not comprise the respective vehicle wheel, or that the respective vehicle wheel is designed separately from the chassis.

The commercial vehicle comprises the vehicle frame and the chassis, and in particular the vehicle wheels, in its completely produced state. For example, the commercial vehicle is designed as an electrically driven commercial vehicle. The respective vehicle frame can be understood in particular as an undercarriage of the commercial vehicle.

For example, the vehicle axle is designed as rear axle of the commercial vehicle. This means that the vehicle axle can be arranged in a rear section of the commercial vehicle, in particular a rear area, in the direction of travel of the commercial vehicle or in the vehicle longitudinal direction of the commercial vehicle. For example, the vehicle axle is designed as a wheel suspension for the vehicle wheels, or the vehicle axle comprises the wheel suspension.

In order to particularly be able to improve maneuvering capability of the commercial vehicle, at least one adjusting device is provided according to the invention, by means of which the vehicle axle can be mounted to pivot relative to the vehicle frame around a pivot axis running oblique or perpendicular to the respective wheel rotational axis to achieve cornering and/or changes of direction of the commercial vehicle. Expressed in other words, the vehicle axle can be pivoted relative to the vehicle frame around the pivot axis to effect the cornering and/or the change of direction of the commercial vehicle by means of the adjusting device. This means that pivoting the vehicle axle around the pivot axis can be or is achieved by the adjusting device. Again, in other words, the vehicle axle, for example a rear axle, is designed as a vehicle axle that can be pivoted relative to the vehicle frame around the pivot axis.

The fact that the vehicle axle can be pivoted, in particular pivotably mounted, to achieve the cornering and/or the change of direction of the vehicle can be understood in particular to mean that the cornering or the change of direction of the commercial vehicle can be carried out or are carried out as a result of the pivoting of the vehicle axle about the pivot axis. Thus, the commercial vehicle can be steered by pivoting the vehicle axle. Therefore, the vehicle axle can be referred to in particular as a steerable or steered vehicle axle. For example, the pivot axis runs in particular at least substantially parallel to the vehicle vertical direction of the commercial vehicle.

In particular, the pivoting of the vehicle axle is not a pivoting, in particular is not a lone pivoting, of the respective vehicle wheel about a wheel pivot axis of the respective vehicle wheel, which wheel pivot axis is in particular different from the pivot axis, for example at a distance from the pivot axis. In comparison, in particular the vehicle axle, in particular the entire vehicle axle, is pivoted or steered around the pivot axis. Thus, it is not just a matter of the wheel angle of the respective vehicle wheel. Therefore, the chassis can in particular be referred to as an adjusting chassis.

For example, the vehicle axle can be pivoted between at least two positions relative to the vehicle frame around the pivot axis. Thus, the vehicle axle can be pivoted into the second position from the first position and vice versa.

For example, in the first position, a longitudinal axis of the vehicle axle runs at a first angle relative to the vehicle transverse axis of the commercial vehicle and in the second position, the longitudinal axis of the vehicle axle runs at a second angle relative to the vehicle transverse axis, different from the first angle. This means that the vehicle axle is in the first position, for example, at the first angle relative to the vehicle transverse axis, and is in the second position, for example, at the second angle relative to the vehicle transverse axis. For example, the longitudinal axis of the vehicle axle and the vehicle transverse axis run parallel to each other in the first position. Therefore, in the first position, the commercial vehicle can drive straight ahead, for example. For example, the longitudinal axis of the vehicle axle and the vehicle transverse axis run oblique to each other in the second position. Therefore, for example, the cornering or the change of direction of the commercial vehicle can at least partially be achieved.

Furthermore, at least one lever that can be pivoted relative to the vehicle frame around a lever axis running oblique or perpendicular to the pivot axis is provided, by means of which lever an adjusting part of the adjusting device that can be moved translationally relative to the vehicle frame is or can be coupled to the vehicle axle in such a way that pivoting the vehicle axle around the pivot axis, in particular at least indirectly, can be achieved by the translational movement of the adjusting part via the pivoting of the lever. Expressed in other words, a translational movement of the adjusting part can be transmitted or converted into a pivoting movement of the lever running around the lever axis, wherein the vehicle axle can be pivoted relative to the vehicle frame around the pivot axis, in particular at least indirectly, by the pivoting movement of the lever. Thus, pivoting the vehicle axle, in particular at least indirectly, can be achieved by means of the adjusting part via the lever. Again, in other words, pivoting the lever around the lever axis is accompanied by the translational movement of the adjusting part, wherein pivoting the vehicle axle around the pivot axis is accompanied by pivoting the lever around the lever axis. Therefore, the vehicle axle can be pivoted with particularly little effort and/or particularly reliably. Furthermore, installation space of the chassis can be designed particularly advantageously, in particular can be kept particularly low.

Alternatively or additionally, it is provided that the at least two vehicle wheels can be driven by means of a drive device of the commercial vehicle. Expressed in other words, the vehicle axle is designed as a drivable vehicle axle. The drive device is provided for driving the commercial vehicle. Expressed again in other words, torque can be supplied for driving the vehicle wheels, in particular arranged on the drive axle, by means of the drive device. This means that the torque supplied by the drive device for driving the commercial vehicle can be transmitted to the vehicle wheels, in particular arranged on the vehicle axle. Furthermore, it is provided that the drive device can be pivoted relative to the vehicle frame around the pivot axis by means of the adjusting device, in particular with the pivoting of the vehicle axle around the pivot axis.

Expressed in other words, the vehicle axle can be or is coupled to the drive device in such a way that when the vehicle axle pivots around the pivot axis, in particular by pivoting the vehicle axle around the pivot axis, the drive device also pivots around the pivot axis. This means that pivoting the drive device around the pivot axis can be achieved by means of the adjusting device, in particular via the vehicle axle. Again, in other words, the drive device is mounted to pivot around the pivot axis relative to the vehicle frame by means of the adjusting device. Therefore, transmitting the torque supplied by the drive device to the vehicle wheels can be realized with particularly little effort. Therefore, for example, the effort involved in producing the chassis can be kept particularly low, wherein for example, production costs of the chassis can be kept particularly low. The fact that the drive device can be pivoted relative to the vehicle frame around the pivot axis by means of the adjusting device when the vehicle axle pivots, is understood to mean in particular that the drive device can be pivoted relative to the vehicle frame around the pivot axis by means of the adjusting device during the pivoting of the vehicle axle. This means that the drive device can be pivoted with the vehicle axle.

Alternatively or additionally, at least one component designed as a gas spring and/or as a fluid damper is provided, by means of which the vehicle axle can be or is supported, in particular directly, on the vehicle frame, for example in the vehicle vertical direction of the commercial vehicle, preferably in a sprung and/or damped manner. Expressed in other words, the vehicle axle is or can be coupled to the vehicle frame in a sprung or damped manner via the component. Therefore, the level of comfort of the commercial vehicle can be particularly increased. For example, the gas spring is designed as a bellows spring. For example, the gas spring or the bellows spring is designed as an air spring. Furthermore, it is provided that the component, in particular the gas spring, has at least one working chamber, designed for receiving a fluid, and at least one piston element partially delimiting the working chamber. Expressed in other words, the fluid is located in the working chamber, wherein the fluid can be acted upon, in particular mechanically, by the piston element. For example, the component has at least one wall which is in particular different from the piston element and designed separately from the piston element and which partially, in particular directly, delimits the working chamber. The piston element is received in the working chamber, for example, so as to be translationally moveable, in particular relative to the wall. For example, the wall is designed as an air bellows. For example, the piston element is designed as a rolling piston. For example, the fluid is air.

The piston element is or can be coupled to the vehicle axle, in particular directly, in such a way that the piston element can be moved translationally relative to the vehicle frame, in particular relative to the wall, by translational movement of the vehicle axle relative to the vehicle frame in a movement direction, wherein capacity of the working chamber can be changed. Expressed in other words, the translational movement of the piston element in the movement direction relative to the vehicle frame, in particular relative to the wall, results from the translational movement of the vehicle axle relative to the vehicle frame in the movement direction. The fluid located in the working chamber can be acted upon, in particular mechanically, by the piston due to the translational movement of the piston element in the movement direction. Thus, the capacity or the fluid can be compressed and/or expanded by means of the piston. Preferably, the movement direction runs in particular at least substantially in the vehicle vertical direction of the commercial vehicle. For example, the pivot axis and the movement direction run parallel to each other. Alternatively, the movement direction and the pivot axis can run oblique to each other.

Furthermore, it is provided that the piston element can be moved in a second movement direction, different to the movement direction, relative to the vehicle frame, in particular relative to the wall, by pivoting the vehicle axle around the pivot axis. Expressed in other words, the movement of the piston element relative to the vehicle frame, in particular relative to the wall, in the second movement direction is accompanied by pivoting of the vehicle axle around the pivot axis. This means that the movement of the piston element in the second movement direction can be achieved by pivoting the vehicle axle around the pivot axis. Therefore, the piston can be moved to balance the pivoting of the vehicle axle in the second movement direction. Therefore, both the pivoting of the vehicle axle around the pivot axis as well as the suspension and/or damping of the vehicle axle can be realized with particularly little effort.

The invention is based, in particular, on the following findings and considerations: For example, the maneuvering capability of a conventional commercial vehicle having a conventional chassis can be particularly restricted, in particular if the commercial vehicle is a vehicle having a semi-trailer. In particular, then this is the case when a wheelbase of the commercial vehicle is particularly high. Typically, maneuvering capability requirements are placed on commercial vehicles, for example for type approval. In accordance with EU Regulation 1230/2012, for example, the commercial vehicle must be able to travel in a complete circle of 360 degrees in both directions within a circular area between two concentric circles, without the outermost points of the commercial vehicle protruding beyond an outer circumference or intruding into the inner circle. The outer circle has a radius of 12.5 meters and the inner circle has a diameter of 5.3 meters. This can in particular be referred to as a turning circle test or as a turning circle.

In comparison, the maneuvering capability of the commercial vehicle can be particularly increased or improved by means of the chassis according to the invention. In addition to the, in particular conventional, steering of vehicle wheels on a front axle of the commercial vehicle, the vehicle axle designed as a rear axle, for example, can be pivoted around the pivot axis, wherein an additional steering effect of the commercial vehicle can be generated. This can particularly increase or improve the steerability of the commercial vehicle, in particular if it has a particularly large wheelbase, for example more than 4,000 millimeters. This means, for example, that requirements for driving in the turning circle, in particular in the case of commercial vehicles with semi-trailers, for example with a particularly large wheelbase or a wheelbase of more than 4,000 millimeters, can be met particularly safely. The chassis according to the invention can thus achieve a particularly high level of maneuvering capability of the commercial vehicle. The particularly high maneuvering capability can also make the commercial vehicle particularly more comfortable, especially for the driver. The comfort can be understood as meaning driving comfort, in particular.

In a further embodiment, it is provided that the adjusting device is designed as a hydraulic adjusting device. Expressed in other words, the vehicle axle can be pivoted hydraulically around the pivot axis relative to the vehicle frame by means of the adjusting device. This means that pivoting the vehicle axle can be achieved by means of the adjusting device at least partially, in particular completely, hydraulically. The adjusting device can therefore in particular be referred to as a hydraulic unit.

For example, the lever axis runs in particular at least substantially in the vehicle transverse direction. For example, the adjusting part can be moved, in particular hydraulically, in an adjusting direction or along an adjusting direction, which, for example, runs in particular at least substantially in the vehicle longitudinal direction. The lever can in particular be referred to as a control lever or as a guide lever.

In a further embodiment, at least one link rod that can be moved translationally relative to the vehicle frame is provided, by means of which the lever is or can be coupled, in particular directly, to the vehicle axle in such a way that pivoting of the vehicle axle can be achieved, in particular directly, by pivoting the lever via the translational movement of the link rod. Expressed in other words, the pivot movement of the lever around the lever axis can be transmitted or converted into a translational movement of the link rod, wherein the vehicle axle can be pivoted around the pivot axis relative to the vehicle frame by the translational movement of the link rod. This means that the vehicle axle can be pivoted around the pivot axis relative to the vehicle frame by means of the adjusting device, in particular via the adjusting part, via the lever and via the link rod. Again, in other words, the translational movement of the link rod is accompanied by the pivoting of the lever around the lever axis, wherein pivoting the vehicle axle around the pivot axis is accompanied by the translational movement of the link rod. Therefore, the vehicle axle can be pivoted with particularly little effort and/or particularly reliably. Furthermore, installation space of the chassis can be designed particularly advantageously, in particular can be kept particularly low.

For example, the link rod can be moved by pivoting the lever around the lever axis in a direction, in particular referred to as a steering direction, which, for example, runs parallel to the adjusting direction of the adjusting part. For example, the steering direction runs in particular at least substantially parallel to the vehicle longitudinal direction of the commercial vehicle.

Preferably, the drive device is designed as an electric drive device. This means that the drive device has at least one electric engine by means of which the commercial vehicle, in particular the respective vehicle wheel can be driven. Expressed in other words, the vehicle axle can be designed as an electrically driven vehicle axle. This means that the commercial vehicle can be designed as an electrically driven commercial vehicle. For example, the commercial vehicle is designed as a battery electric commercial vehicle or as a hybrid vehicle. Alternatively, the commercial vehicle can be designed as a fuel cell system vehicle, for example.

The drive device can be designed separately from the chassis. This means that the chassis does not comprise the drive device. Alternatively, the chassis can comprise the drive device. This means that the drive device can be a part of the chassis.

In a further embodiment, it is provided that the pivot axis runs through the vehicle axle. Expressed in other words, the pivot axis intersects the vehicle axle. This means that the vehicle axle can be pivoted about a pivot point, referred to in particular as a fulcrum, relative to the vehicle frame in a plane extending perpendicular to the pivot axis, in particular an imaginary plane, wherein the pivot point is located on the vehicle axle or is arranged within the vehicle axle. The pivot point is thus not spaced apart from the vehicle axle. Therefore, kinematics can be designed particularly advantageously for pivoting the vehicle axle, in particular can be designed with particularly little effort. In particular, movements of at least one component of the vehicle axle caused by the pivoting can be kept to a minimum. The pivot point can be understood as an instantaneous center of rotation.

In a further embodiment, it is provided that the vehicle axle is designed as a beam axle. Expressed in other words, the vehicle wheels, which are each preferably arranged on opposing sides in the vehicle transverse direction of the commercial vehicle, are connected to each other via at least one rigid axle body. This means that the vehicle axle is not designed as independent suspension, for example, or does not comprise the independent suspension. Therefore, robustness of the chassis can be particularly increased. Furthermore, the chassis can be designed with particularly little effort, in particular in a particularly cost-effective manner.

For example, the vehicle axle can be moved between at least two positions in the movement direction or along the movement direction. For example, the piston element can be moved in the movement direction or along the movement direction between at least two piston positions relative to the vehicle frame, in particular relative to the wall. For example, the vehicle axle and the piston element are coupled to each other, in particular mechanically, in such a way that the piston element is in the first piston position when the vehicle axle is in the first position and that the piston element is in the second piston position when the vehicle axle is in the second position. This means that the piston element can be moved from the first piston position to the second piston position by moving the vehicle axle from the first position to the second position, and vice versa.

The movement of the piston element in the second movement direction may be a translational movement. This means that the piston element can be moved in the second movement direction translationally relative to the vehicle frame, in particular the wall. In particular, the piston element can move on a circular path, extending in particular around the pivot axis, or on an arc section of the circular path, as a result of the pivoting of the vehicle axle. For example, the second movement direction runs oblique or perpendicular to the movement direction, in particular referred to as a first movement direction. For example, the second movement direction runs in the vehicle longitudinal direction and/or in the vehicle transverse direction of the commercial vehicle.

For example, it is provided that the capacity of the working chamber is not changed, in particular is at least substantially not changed, when the piston element moves in the second movement direction. This means that the piston element can be moved in the second movement direction or along the second movement direction relative to the vehicle frame, in particular relative to the wall, without the capacity of the working chamber changing, in particular as a result of the movement of the piston in the second direction of movement, or such that the capacity changes less when the piston element is moved, in particular over a distance, along the second movement direction than when the piston element is moved, in particular over the distance, along the first movement direction. Thus, the capacity of the working chamber can at least essentially stay constant when the piston moves in the second movement direction.

A further aspect relates to a commercial vehicle, which has a chassis according to the invention. Advantages and advantageous embodiments of the further aspect are considered as advantages and advantageous embodiments of the invention and vice versa.

Further advantages, features and details of the invention can be seen from the following description of preferred exemplary embodiments and from the drawings. The features and combinations of features mentioned above in the description as well as the features and combinations of features mentioned below in the description of the figures and/or shown alone in the figures can be used not only in the combination indicated in each case, but also in other combinations or on their own, without leaving the scope of the invention.

### BRIEF DESCRIPTION OF THE DRAWING FIGURES

Here:

FIG. 1 shows a schematic partial view of a commercial vehicle from above, which has a chassis according to the invention; and

FIG. 2 shows a schematic and perspective partial view of a commercial vehicle, which has a chassis according to the invention; and

FIG. 3 shows a schematic partial view of a commercial vehicle from below, which has a chassis according to the invention which is located in a first position; and

FIG. 4 shows a schematic partial view of a commercial vehicle from below, which has a chassis according to the invention which is located in a second position; and

FIG. 5 shows a schematic partial view of a commercial vehicle from above, which has a chassis according to the invention according to a further embodiment; and

FIG. 6 shows a schematic partial section view of a component, designed as a gas spring, of a chassis according to the invention.

In the figures, identical or functionally identical elements are provided with the same reference signs.

### DETAILED DESCRIPTION

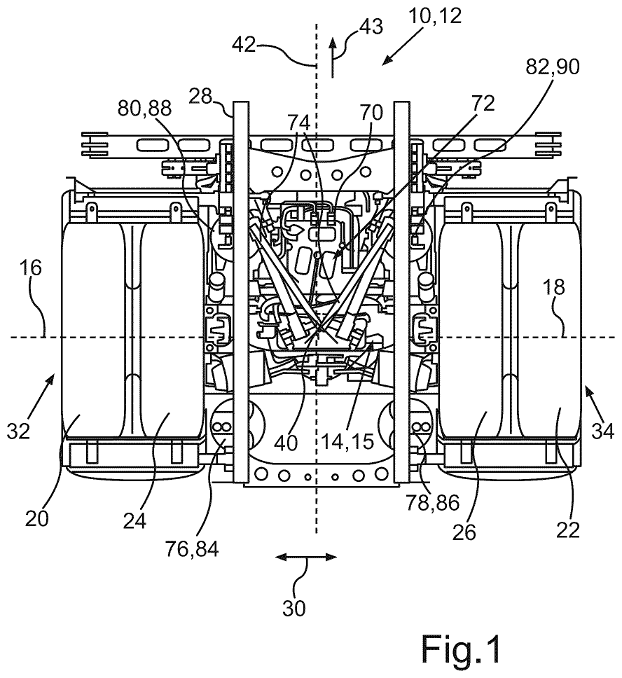

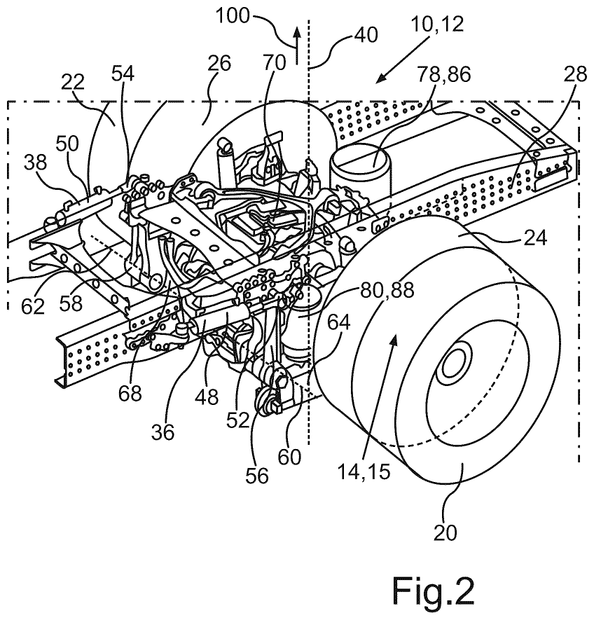

FIG. 1 shows a commercial vehicle 10 from above in a schematic and perspective partial view, which has a chassis 12. Thus, FIG. 1 shows a schematic plan view of the chassis 12 or the commercial vehicle 10. FIG. 2 shows the commercial vehicle 10 or the chassis 12 in a schematic and perspective partial view.

The chassis 12 has a vehicle axle 14, which is designed as a rear axle of the commercial vehicle 10 in the exemplary embodiment. For example, the vehicle axle 14 is designed as beam axle 15. At least two, for example four, vehicle wheels 20, 22, 24, 26 of the commercial vehicle 10 that can be rotated around a respective wheel rotational axis 16, 18 can or are supported on a vehicle frame 28 of the commercial vehicle 10 via the vehicle axle 14. A first of the vehicle wheels 20 is arranged on a first side 32 of the commercial vehicle 10 in relation to a vehicle transverse direction 30 of the commercial vehicle 10, and a second of the vehicle wheels 22 is arranged on a second side 34, different to the first side 32, in relation to the vehicle transverse direction 30. In the exemplary embodiment, a third of the vehicle wheels 24 is arranged on the first side 32 and the fourth of the vehicle wheels 26 is arranged on the second side 34. The first and the second vehicle wheel 20, 22 or the third and the fourth vehicle wheel 24, 26 are spaced apart from each other in the vehicle transverse direction 30. For example, the first and the third vehicle wheel 20, 24 can be rotated around a first of the wheel rotational axes 16. For example, the second and the fourth vehicle wheel 22, 26 can be rotated around a second of the wheel rotational axes 18. The wheel rotational axes 16, 18 run preferably, in particular at least substantially, parallel to each other.

In order to particularly be able to improve maneuvering capability of the commercial vehicle 10, it is provided that the chassis 12 has at least one adjusting device 36, 38 by means of which the vehicle axle 14 can be pivotably mounted to pivot relative to the vehicle frame 28 around a pivot axis 40 running oblique or perpendicular to the respective wheel rotational axis 16, 18 to achieve cornering or changes of direction of the commercial vehicle 10. In the exemplary embodiment, two adjusting devices 36, 38 are provided, by means of which the vehicle axle 14 can be pivoted around the pivot axis 40 relative to the vehicle frame 28. In the exemplary embodiment, a first of the adjusting devices 36 is arranged on the first side 32 and the second of the adjusting devices 38 is arranged on the second side 34.

The respective vehicle wheel 20, 22, 24, 26 is arranged on the vehicle axle 14 or is coupled, in particular mechanically, to the vehicle axle 14 in such a way that the respective vehicle wheel 20, 22, 24, 26 can be pivoted with the vehicle axle 14 when the vehicle axle 14 pivots around the pivot axis 40. Therefore, the respective vehicle wheel 20, 22, 24, 26 can be pivoted or deflected with respect to the vehicle longitudinal axis 42 of the commercial vehicle 10, in particular by pivoting with the vehicle axle 14, wherein cornering or the change of direction of the commercial vehicle 10 can be achieved. A direction of travel of the commercial vehicle 10 is illustrated in FIG. 1 by means of an arrow 43.

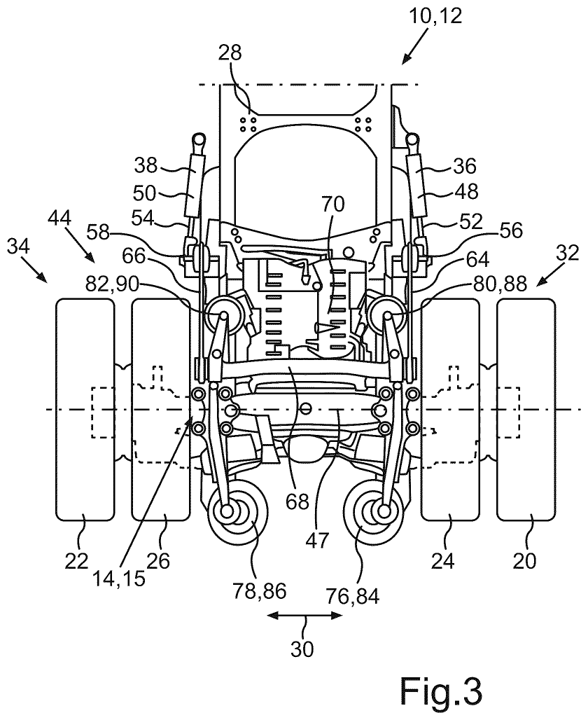

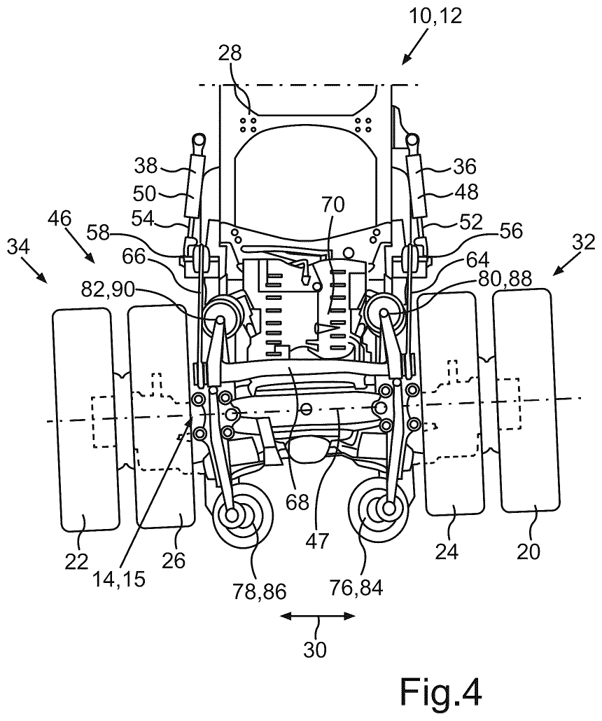

FIG. 3 and FIG. 4 show in each case a respective schematic partial view of the commercial vehicle 10 from below. Thus, in each case the chassis 12 or the commercial vehicle 10 is shown in FIG. 3 and FIG. 4 in a respective schematic bottom view. The vehicle axle 14 can be pivoted between at least two positions 44, 46 relative to the vehicle frame 28 around the pivot axis 40, by means of the respective adjusting device 36, 38. FIG. 3 shows the vehicle axle 14 in the first position 44. FIG. 4 shows the vehicle axle 14 in the second position 46. In the second position 46, the vehicle axle 14, in particular a longitudinal axis 47 of the vehicle axle 14, is pivoted or deflected by an angle with respect to the first position 44, in particular around the pivot axis 40. The angle or a maximum possible value of the angle is 2.3 degrees, for example. Alternatively, the angle can be smaller than 2.3 degrees. This means that the vehicle axle 14 can be pivoted for example by a maximum of 2.3 degrees around the pivot axis 40, by means of the respective adjusting device 36, 38.

Preferably, in each case, the respective adjusting device 36, 38 is designed as a hydraulic adjusting device 36, 38. This means that the respective adjusting device 36, 38 has a respective, in particular cylindrical, hydraulic unit, for example. For example, the respective adjusting device 36, 38 has in each case a respective cylinder 48, 50 which in each case is designed to receive a fluid. The respective cylinder 48, 50 is partially delimited by a respective cylinder wall, for example.

Preferably, the respective adjusting device 36, 38 has a respective adjusting part 52, 54 that can be moved translationally relative to the vehicle frame 28. The respective adjusting part 52, 54 is designed as a respective piston, for example, which in each case is received in the respective cylinder 48, 50 so as to be translationally moveable, in particular relative to the respective cylinder wall. Preferably, the respective adjusting part 52, 54 partially delimits the respective cylinder 48, 50. A first of the adjusting parts 52 is arranged on the first side 32 and the second of the adjusting parts 54 is arranged on the second side 34.

For example, at least one, in particular electrical, pump element is provided, by means of which the fluid can be delivered into the respective cylinder 48, 50. For example, at least one storage element, also in particular referred to as a tank, is provided in which the fluid can be stored. Preferably, the fluid stored in the storage element can be discharged from the storage element by means of the pump element and can be delivered into the respective cylinder 48, 50. For example, a length of the storage element is 300 millimeters. For example, a width of the storage element is 200 millimeters. For example, a height of the storage element is 200 millimeters. Preferably, at least one electronic computing device is provided for controlling the respective adjusting device 36, 38. For example, the respective adjusting device 36, 38 comprises a sensor element, in particular referred to as a position sensor, by means of which a respective position of the respective adjusting part 52, 54 can be detected or determined.

In a further embodiment, it is provided that the chassis 12 has at least one lever 56. In the exemplary embodiment, two levers 56, 58 are provided. A first of the levers 56 is arranged on the first side 32 and the second of the levers 58 is arranged on the second side 34. The respective lever 56, 58 can be pivoted relative to the vehicle frame 28 around a respective lever axis 60, 62 of the respective lever 56, 58, wherein the respective lever axis 60, 62 runs oblique or perpendicular to the pivot axis 40. For example, a respective support is provided for the respective lever 56, 58, which is arranged on the respective side 32, 34, for example on a respective front suspension.

Preferably, it is provided that the respective adjusting part 52, 54 is or can be coupled, in particular mechanically, to the vehicle axle 14 via the respective lever 58, 60 in such a way that pivoting of the vehicle axle 14 can be achieved by the translational movement of the respective adjusting part 52, 54 via the pivoting of the respective lever 56, 58. In this case, the first lever 56 is coupled to the first adjusting part 52. The second lever 58 is coupled to the second adjusting part 54. The first lever 56 can be pivoted around a first of the lever axes 60. The second lever 58 can be pivoted around the second of the lever axes 62.

Preferably, the chassis 12 comprises at least one link rod 64, 66 that can be moved translationally relative to the vehicle frame 28. In the exemplary embodiment, two link rods 64, 66 are provided. A first of the link rods 64 is arranged on the first side 32 and the second of the link rods 66 is arranged on the second side 34. The respective link rod 64, 66 in each case can be moved translationally relative to the vehicle frame 28. The respective lever 56, 58 is or can be coupled, in particular mechanically, to the vehicle axle 14 via the respective link rod 64, 66, in such a way that pivoting of the vehicle axle 14 can be achieved by pivoting the respective lever 56, 58 via the translational movement of the respective link rod 64, 66. In this case, the first link rod 64 is, in particular mechanically, coupled to the first lever 56. The second link rod 66 is, in particular mechanically, coupled to the second lever 58.

A respective transmission between the respective translational movement of the respective adjusting part 52, 54 and the respective link rod 64, 66 can be achieved by means of the respective lever 56, 58. In this case, a ratio of the transmission between the respective movement of the respective adjusting part 52, 54 and the respective movement of the respective link rod 64, 66 can be 2.6, for example. Therefore, the respective adjusting device 36, 38, in particular the respective cylinder 48, 50 can be designed to be particularly compact, wherein in particular particularly high adjustment forces can simultaneously be transmitted onto the vehicle axle 14 for pivoting the vehicle axle 14.

Preferably, the link rods 64, 66 can be connected to each other, in particular directly, via a link rod part 68. Therefore, the link rods 64, 66 and the link rod part 68 together can form a stabilizer of the chassis 12 or the commercial vehicle 10, in particular referred to as an anti-roll bar. The respective link rod 64, 66 extends preferably in each case, in particular at least substantially, in the vehicle longitudinal direction of the commercial vehicle 10. The link rods 66, 64 and the link rod part 68 can each be designed to be separate to each other or designed together as one-piece.

Preferably, it is provided that the adjusting parts 52, 54 of the respective adjusting device 36, 38 are each moved inversely, i.e., counter-rotating, to each other. For example, the adjusting devices 36, 38, in particular the adjusting parts 52, 54 are coupled, in particular mechanically, to each other via the vehicle axle 14 in such a way that the translation movement of the second adjusting part 54 in a second adjusting direction opposing the first adjusting direction coincides with the translational movement of the first adjusting part 52, or takes place as a result of the translational movement of the first adjusting part 52, in a first adjusting direction. In particular, pivoting the second lever 58 around a second pivoting direction, opposing the first pivoting direction, coincides with pivoting the first lever 56 in a first pivoting direction. In particular, a translational movement of the second link rod 66 in a second direction, opposing the first direction, coincides with the translational movement of the first link rod 64 in a first direction. Therefore, the first vehicle wheel 20 and the third vehicle wheel 24 can be moved forwards in the vehicle longitudinal direction of the commercial vehicle 10, whilst the second vehicle wheel 22 and the fourth vehicle wheel 26 can be moved backwards in the vehicle longitudinal direction of the commercial vehicle 10 and vice versa.

In a further embodiment, the commercial vehicle 10 has at least one drive device 70, by means of which the commercial vehicle 10 can be driven. Preferably, the drive device 70 is designed as an electric drive device 70. For example, the drive device 70 has two electric engines, by means of which the commercial vehicle 10 can be driven. Preferably, it is provided that the vehicle wheels 20, 22, 24, 26 can be driven by means of the drive device 70. In this case, it is provided, for example, that the electric engines drive a common output shaft, which is or can be connected in a torque-transmitting manner to the vehicle wheels 20, 22, 24, 26. The drive device 70 can therefore in particular be referred to as a twin electric engine.

Preferably, it is provided that the drive device 70 can be pivoted relative to the vehicle frame 28, around the pivot axis 40, by means of the respective adjusting device 36, 38, in particular during the pivoting of the vehicle axle 14 around the pivot axis 40. For example, the drive device 70 comprises a cooling device 72, which can be designed as a cooling module, for example.

Preferably, it is provided that the pivot axis 40 runs through the vehicle axle 14, in particular the longitudinal axis 47 of the vehicle axle 14. This means that the pivot axis 40 intersect the vehicle axle 14, in particular the longitudinal axis 47. For example, two A-arms 74 are provided which are preferably connected to each other at a common intersection. Preferably, the pivot axis 40 runs through the intersection. Therefore, transverse movements can be particularly minimized by pivoting the vehicle axle 14.

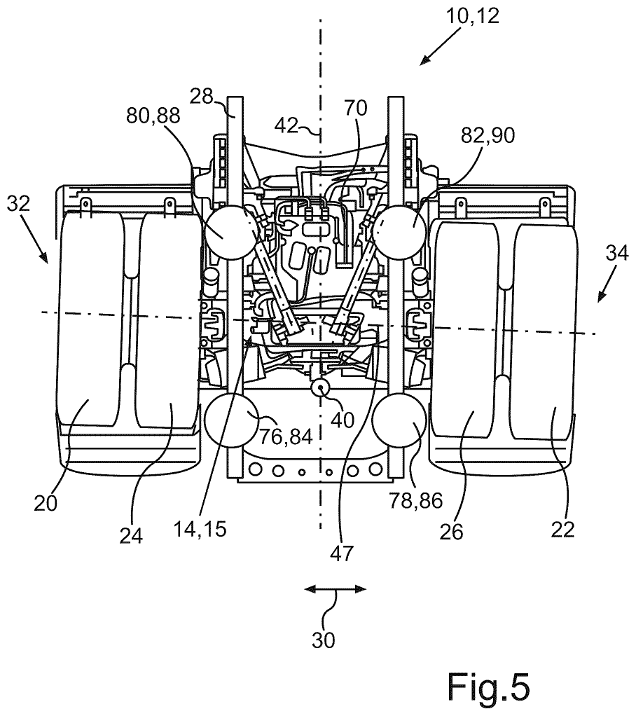

FIG. 5 shows the commercial vehicle 10 or the chassis 12 in a schematic plan view according to a further embodiment in which the pivot axis 40 is located outside the vehicle axle 14.

In a further embodiment, the chassis 12 comprises at least one component 84, 86, 88, 90, designed as a gas spring 76, 78, 80, 82, wherein four of the gas springs 76, 78, 80, 82 or the components 84, 86, 88, 90 are provided in the exemplary embodiment. The vehicle axle 14 can be or is supported upwards on the vehicle frame 28, in particular spring-loaded, for example in the vehicle vertical direction of the commercial vehicle via the respective component 84, 86, 88, 90.

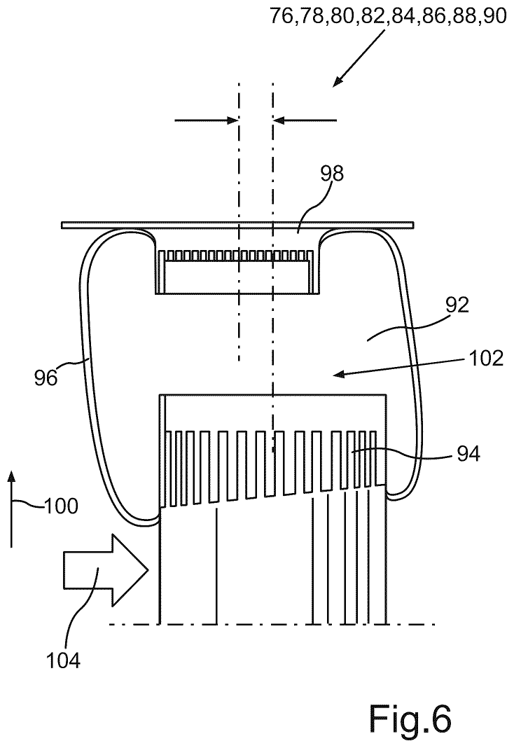

FIG. 6 shows an exemplary schematic partial view of one of the respective components 84, 86, 88, 90 in each case designed as a gas spring 76, 78, 80, 82. The respective gas spring 76, 78, 80, 82 is designed as a respective air spring and/or as a bellows spring, for example.

In a further embodiment, the respective component 84, 86, 88, 90 or the respective gas spring 76, 78, 80, 82 in each case has a respective working chamber 92, designed for receiving a fluid, and a respective piston element 94 partially delimiting the respective working chamber 92. The respective working chamber 92 is partially delimited by a respective wall 96, in particular different from the piston element 94. The respective wall 96 is designed as respective air bellows, for example. For example, the respective piston element 94 is designed as a respective rolling piston. In the exemplary embodiment shown in the FIG. 6, the respective working chamber 92 is partially delimited by a respective head plate 98, in particular upwards in the vehicle vertical direction of the commercial vehicle 10. Preferably, the respective piston element 94 delimits the respective working chamber 92 partially downwards in the vehicle vertical direction of the commercial vehicle 10. For example, the respective component 84, 86, 88, 90 or the respective gas spring 76, 78, 80, 92 each has a bionic design.

Preferably, the respective piston element 94 is coupled, in particular mechanically, to the vehicle axle 14, in such a way that the respective piston element 94 can be or is moved int a respective movement direction 100 translationally relative to the vehicle frame 28 by the translational movement of the vehicle axle 14 relative to the vehicle frame 28 in the respective movement direction 100, wherein a respective capacity 102 of the respective working chamber 92 can be or is changed. The respective movement direction 100 runs parallel to the vehicle vertical direction of the commercial vehicle 10 and/or parallel to the pivot axis 40, for example.

Preferably, the respective piston element 94 is coupled, in particular mechanically, to the vehicle axle 14, in such a way that the respective piston element 94 can be or is moved relative to the vehicle frame 28 in a second movement direction 104, different from the movement direction 100, by the pivoting of the vehicle axle 14 around the pivot axis 40. The respective movement of the respective piston element 94 in the second movement direction 104 may preferably be a respective translational movement which, for example, has a lateral component, i.e. a component running in the vehicle transverse direction 30, wherein the movement in particular can be referred to as a lateral movement. The movement of the respective piston element 94 in the second movement direction 104 can cause additional forces, in particular forces referred to as air forces, in particular against the head plate 98, which forces can be up to 2.2 kilo newtons per respective gas spring 76, 78, 80, 82, for example. Therefore, a respective movement of the respective piston element 94 caused by the pivoting of the vehicle axle 14 can be balanced out. Particularly if the pivot axis 40 runs through the vehicle axle 14, the movement of the respective piston element 94 in the second movement direction 104 can be kept particularly low when the vehicle axle 14 pivots.

In the exemplary embodiment, a first of the components 84 is arranged on the first side 32 and a second of the components 86 is arranged on the second side 34. A third of the components 88 is arranged on the first side 32 and the fourth of the components 90 is arranged on the second side 34. For example, the first component 84 is arranged behind the third component 88 in the vehicle longitudinal direction of the commercial vehicle 10. For example, the second component 86 is arranged behind the fourth component 90 in the vehicle longitudinal direction of the commercial vehicle 10. Preferably, a diameter of the first component 84 is greater than a diameter of the third component 88 and/or a diameter of the second component 86 is preferably greater than a diameter of the fourth component 90. For example, the diameter of the first component 84 and/or of the second component 86 is 305 millimeters. For example, the diameter of the third component 88 and/or the diameter of the fourth component 90 is 195 millimeters. For example, the first and/or the second component 84, 86, in particular an axial center of the first and/or the second component 84, 86, is arranged further inwards in the vehicle transverse direction 30 than the third and/or the fourth component 88, 90, in particular as an axial center of the third and/or of the fourth component 88, 90. Therefore, a respective distance between the respective component 84, 86 and the respective vehicle wheel 20, 22, 24, 26 can be guaranteed when the vehicle axle 14 pivots.

### List of Reference Signs

10 commercial vehicle
12 chassis
14 vehicle axle
15 beam axle
16 first wheel rotational axis
18 second wheel rotational axis
20 first vehicle wheel
22 second vehicle wheel
24 third vehicle wheel
26 fourth vehicle wheel
28 vehicle frame
30 vehicle transverse direction
32 first side
34 second side
36 first adjusting device
38 second adjusting device
40 pivot axis
42 vehicle longitudinal direction
43 arrow
44 first position
46 second position
47 longitudinal axis
48 cylinder
50 cylinder
52 first adjusting part
54 second adjusting part
56 first lever
58 second lever
60 first lever axis
62 second lever axis
64 first link rod
66 second link rod
68 link rod part
70 drive device
72 cooling device
74 A-arms
76 gas spring
78 gas spring
80 gas spring
82 gas spring
84 first component
86 second component
88 third component
90 fourth component
92 working chamber
94 piston element
96 wall
98 head plate
100 movement direction
102 capacity
104 second movement direction

1-5. (canceled)

6. A chassis for a commercial vehicle, the chassis comprising:
a vehicle axle configured to support at least two vehicle wheels of the commercial vehicle on a vehicle frame of the commercial vehicle, wherein the at least two vehicle wheels are around a respective wheel rotational axis;
at least one adjusting device configured so that the vehicle axle is mounted to pivot relative to the vehicle frame around a pivot axis running oblique or perpendicular to the respective wheel rotational axis to achieve cornering or changes of direction of the commercial vehicle,
wherein
the chassis further comprises at least one lever pivotable relative to the vehicle frame around a lever axis running oblique or perpendicular to the pivot axis, wherein, by the at least one lever, an adjusting part of the adjusting device is moveable translationally relative to the vehicle frame, wherein the adjusting part is coupled to the vehicle axle in such a way that pivoting the vehicle axle can be achieved by the translational movement of the adjusting part via the pivoting of the lever,
the at least two vehicle wheels are drivable by a drive device of the commercial vehicle and the drive device is pivotable relative to the vehicle frame around the pivot axis by the adjusting device, or
the chassis further comprises at least one gas spring configured so that the vehicle axle is supported on the vehicle frame, wherein the at least one gas spring has a working chamber configured to receive a fluid and a piston element at least partially delimiting the working chamber and coupled to the vehicle axle in such a way that
the piston element is movable translationally in a first movement direction relative to the vehicle frame by translational movement of the vehicle axle relative to the vehicle frame in the first movement direction, wherein capacity of the working chamber can be changed, and
the piston element is movable in a second movement direction relative to the vehicle frame, different from the first movement direction, by pivoting the vehicle axle around the pivot axis.

7. The chassis of claim 6, wherein the adjusting device is a hydraulic adjusting device.

8. The chassis of claim 6, wherein a link rod, which is movable translationally relative to the vehicle frame, is configured to couple the lever to the vehicle axle in such a way that pivoting of the vehicle axle can be achieved by pivoting the lever via the translational movement of the link rod.

9. The chassis of claim 6, wherein the pivot axis runs through the vehicle axle.

10. The chassis of claim 6, wherein the vehicle axle is a beam axle.
